(19) United States
(12) Patent Application Publication
(10) Pub. No.: US 2016/0155094 A1
(43) Pub. Date: Jun. 2, 2016

(54) APPOINTMENT ROBOT

(71) Applicant: SPEATE AG, Meilen (CH)

(72) Inventor: Rudolf A. Rentsch, Meilen (CH)

(73) Assignee: Speate AG, Meilen (CH)

(21) Appl. No.: 14/905,486

(22) PCT Filed: Jul. 15, 2014
(86) PCT No.: PCT/EP2014/065072

§ 371 Date: Jan. 15, 2016

(30) Foreign Application Priority Data
Jul. 15, 2013 (CH) 01260/13

(51) Int. Cl. G06Q 10/10

(52) U.S. Cl. CPC G06Q 10/1095

(57) ABSTRACT

The invention relates to a system for an appointment robot (R), the system comprising a master module (MA) and a plurality of client modules (CA1, CA2, CA3). The master module (MA) is provided for the purpose of accessing diary entries and creating an appointment robot (R) with a parameter set (P) and command set (B) connected thereto and using a data network to transmit said appointment robot to one or more client modules (CA1, CA2, CA3) and receiving groups or lists of provisional appointment entries (T1, T2, T3) from each of the client modules (CA1, CA2, CA3) and evaluating said groups or lists in order to ascertain one or more diary bookings. The client modules (CA1, CA2, CA3) are provided for the purpose of each receiving an appointment robot (R) with parameter set (P) and command set (B) connected thereto from a master module (MA) and accessing diary entries and creating a group of provisional appointments (T1, T2, T3) and transmitting said group to the master modules (MA).

### CROSS REFERENCE TO RELATED APPLICATIONS

This application is a 371 National State application of International Application No. PCT/EP2014/065072 filed on Jul. 15, 2014, which claims priority of Swiss Serial Number 01260/13 filed on Jul. 15, 2013, both of which are incorporated herein by reference in their entireties.

### BACKGROUND OF THE INVENTION

1. Field of the Invention

The present invention relates to a system, a method, and devices for an appointment robot according to the preambles of the independent claims.

2. Description of the Prior Art

Today there are various known systems for determining appointments, managing appointments and settling appointments, often under the heading of “organizer” or similar designations. Most of these systems are used for simply determining and managing appointments and can be summarized under the heading “electronic agenda” inasmuch as they use electronic technologies. Corresponding known approaches require complex interactions among operators and are therefore not only very inconvenient in more complex environments but are also of hardly any benefit. Although the present invention pursues entirely different approaches, the corresponding background technologies should be discussed briefly.

For example, the Calendar program (known by the names Calendar and iCal, depending on the version) is supplied with the MAC OS X™ operating system. This program supports various calendars for appointments and tasks. To display the calendar, a color can be assigned to each calendar. Each separate calendar can be published over a server (e.g., WebDAV). Other published calendars (holidays, movie schedules, etc.) can be received by subscription. However, this does not support group calendars, in which a group of people can release their calendar entries for mutual reading and writing so that appointments can be synchronized.

RFC 5545 (Request for Comment) of the IETF (Internet Engineering Task Force) defines an iCalendar data format for exchanging calendar information, such as events, tasks, handbook entries and availability information. The iCalendar format is suitable as an exchange format between applications and systems and can be transmitted over data networks. It supports tasks such as appointment requests, appointment responses, changes in appointments or cancellation of appointments. Furthermore, the data format can be used in the sense of inquiries and responses pertaining to free times or busy times.

Electronic agendas are to be differentiated from systems which do not relate to the actual determination of appointments, confirmation of appointments or setting of appointments but instead relate to the upstream process, which is referred to here as appointment synchronization and/or appointment coordination. Such systems are still not very widespread today. One of these systems is Doodle™ which is provided for finding an appointment suitable for several people. These people are divided into an appointment coordinator and several (potential) appointment participants. The appointment coordinator manually detects multiple proposed appointments according to his own agenda and then invites multiple appointment participants to agree, by manual input, to the proposed appointments that fit with their own respective agendas. The appointment coordinator monitors whether the appointment participants who have been invited have expressed their positions about the proposed appointments and he transmits invitation reminders which can automatically be transmitted to those people who have not yet stated their position regarding the proposed appointments. After all the appointment participants have made their entries, a manual evaluation by the appointment coordinator is necessary, and if there is an unfavorable constellation, for example, if several appointments have been agreed upon with equal frequency or if no appointment has been agreed upon by all the appointment participants, additional clarifications or a new appointment request are required. Finally, an appointment confirmation is sent to the appointment participants and/or an appointment is set—again by manual work.

Electronic agendas today make it possible to determine appointments for a certain user, save them, retrieve them and modify them. As a rule, it is also possible to access electronic agendas of other users, to see them (in particular within corporate units) and possibly to manually detect conflicts with these appointments and to avoid them in advance in appointment entries. Such systems presuppose, first of all, that the several users are using the same system and allow mutual viewing of electronic agendas by means of suitable hardware or software settings. Scheduling and synchronizing appointments also take place here fundamentally manually and require a great deal of personal effort.

Traditional systems fail in particular when appointments are to be synchronized quickly among several people because the synchronization effort increases in a nonlinear fashion and such partially automated processes hardly offer any advantages in comparison with a purely manual approach and/or tend to be problematic. The effort to acquire and manage appointments in such systems results in a disproportionate effort. Known approaches are completely inadequate when a rapid synchronization of appointments is necessary within a few hours or even minutes. In this case the need for manual review by the people involved makes a solution impossible. Several feedback loops are often necessary until a synchronization of appointments can be concluded successfully.

Another previously unsolved problem is the fact that the known appointment coordination systems require relatively large user interfaces to be able to perform the desired comparison of appointments. Even the better ones of these systems do not make it possible to simultaneously synchronize appointments over longer periods of time with existing appointments.

### BRIEF SUMMARY OF THE INVENTION

The object of the invention is to overcome at least individual aforementioned disadvantages of the prior art and to allow a rapid and highly efficiently automated synchronization of appointments.

This object is achieved by the features of the independent patent claims.

The system for an appointment robot according to the invention comprises a master module and one or more client modules. The master module is provided for accessing calendar entries and creating an appointment robot with a set of parameters associated with it as well as with a set of commands and to transmit the parameter set and the command set over a data network to one or more client modules and to receive groups and/or lists with provisional appointment entries from the client modules and evaluate them in order to ascertain one or more calendar bookings. The one or more client modules are provided to receive an appointment robot having a parameter set associated with it as well as a command set from a master module and to access calendar entries and to create a group and/or a list with provisional appointments and transmit it to the master module. Because of the appointment robot, the system is capable of ascertaining and entering an appointment booking and/or calendar booking completely automatically.

The invention is directed at the idea of an appointment robot, which is preferably stored in a capsule to correspond to security guidelines. The appointment robot is transmitted peer-to-peer between the participating modules, which are preferably installed in mobile terminals, such as smartphones, etc. For transmission of the appointment robot, data networks, which are available to the mobile terminals, are used. The appointment robot can be created rapidly and also made available rapidly to the participating modules. Furthermore, the evaluation of the appointment robot based on the parameter set and the command set associated with it is flexible and highly efficient for synchronizing appointments between the modules involved and for obtaining the desired synchronization of appointments in calendars, which can be accessed by the modules involved.

In one embodiment, the master module is provided to transmit a calendar booking that has been detected to one or more client modules and to receive an acknowledgment from the one or more client modules and to store the calendar booking. The master module is capable of transmitting a (definitive or optional and/or provisional) calendar booking and to receive the corresponding acknowledgment. The calendar booking can be entered into a calendar on the master before or after the acknowledgment.

In one embodiment, the one or more client modules are provided to receive a calendar booking from a master module and to save the calendar booking and to transmit an acknowledgment to the master module. The one or more client modules are capable of transmitting an acknowledgment to the master module based on receipt of a calendar booking. The calendar booking and/or the corresponding calendar appointment is/are entered into a calendar on the respective client.

In one embodiment, the master module and/or the one or more client modules is/are provided to access calendar entries stored in a plurality of calendar databanks, wherein the calendar databanks comprise at least one calendar databank of a user assigned to the master module and/or the client module and a calendar databank for storing provisional appointments. Multiple calendars may be taken into account for ascertaining an appointment booking and/or calendar booking. When it is stated in the present context that the saved calendar entries are accessed, this is not to be understood to mean that their contents must be accessible. Instead, within the context of the invention, this makes use of the advantage that the client module will read out and transmit only the free appointment options (more or less the empty spots) (by means of knowledge of the saved calendar entries).

The invention is directed at the idea that a first calendar is provided for entering and displaying the calendar data of the user. Furthermore, a second calendar is provided for entering and displaying provisional appointments. By dividing them into the fixed user appointments and the provisional appointments, this yields, on the one hand, the possibility of a user interface that can be managed in a convenient and comprehensible manner for the user. On the other hand, by saving fixed user appointments in a first calendar and saving provisional appointments in a second calendar, it is possible to compare and synchronize appointments through the system automatically, efficiently, accurately and reliably.

The invention is directed at the idea that the respective calendars pertaining to the user, i.e., at least the first calendar with the fixed appointments for the user, the second calendar with the provisional calendar as well as additional subscribed calendars are displayed in a calendar matrix. The calendar matrix permits efficient management of appointments by the user. Multiple calendars are arranged row by row, where the individual calendars are aligned with one another chronologically. One matrix element of the calendar matrix is thus defined by identification of a calendar and a point in time, an interval of time, etc. The alignment in time of the individual rows of the calendar permits a direct comparison of appointments. The user can rapidly review fixed and provisional appointments by displaying them by the day, the week or the month, etc. Calendars have read authorization and/or write authorization. Entering an appointment into a calendar with write authorization can be done quickly and comprehensively by drag-and-drop, wherein the user can take the various calendars into account at the same time when they are entered because they can be displayed in the form of a calendar matrix. This permits rapid creation of an appointment that is to be used for synchronization of appointments with other participants in the system. It also permits rapid review and optional confirmation of one or more provisional appointments that were entered based on an appointment robot made available to the respective mobile terminal of the user.

In one embodiment, the master module and the one or more client modules are provided to access calendar entries in a local memory assigned to the master module and/or the client module and/or to access calendar entries in a memory that is accessible over a data network. In one variant, the local memory can be accessed by means of a calendar module, which manages a calendar memory. Access to memories that can be accessed via a data network may pertain to a calendar published on an Internet server.

In one embodiment, the master module and/or the one or more client modules is/are provided to create the parameter set and command set associated with the appointment robot, to create groups and/or lists with provisional calendar appointments and/or a detected calendar entry in a data format that includes one or more entries in an iCalendar data format. This improves compatibility with existing calendars in particular.

In one embodiment, the master module and/or the one or more client modules is/are provided to exchange data between a master module according to an Extensible Messaging and Presence Protocol. The data transmission can therefore be based on a robust data transmission protocol, which is tested and widely used. Corresponding communications protocols can be used in other embodiments.

In one embodiment, the master module and/or the one or more client modules is/are provided to secure data such as in particular an appointment robot having an associated parameter set as well as a command set, provisional appointment entries, etc. before transmission in a capsule comprising a hash, an electronic signature and/or electronic encryption and/or to check the secured capsule on receipt. The data integrity is ensured by securing the appointment robot in a capsule.

In one embodiment, the master module and/or the one or more client modules is/are provided to create and transmit and/or receive a parameter set associated with the appointment robot, comprising one or more of the following parameters: calendar date, starting time and ending time, address information of appointment participants, appointment meeting location, appointment title. The parameters required for determining an appointment booking and/or calendar booking can thereby be made available.

In one embodiment, the master module and/or the one or more client modules is/are provided to create and transmit and/or to receive a command set associated with the appointment robot, comprising one or more of the following commands: prioritization of information contained in the parameter set, obligatory specifications pertaining to information contained in the parameter set, criteria for determining groups and/or lists with free appointments. Therefore, flexible and efficient commands, which are necessary for determining an appointment booking and/or a calendar booking, can be defined.

In a special embodiment of the system, calendar information of the master module and/or individual client modules may also be displayed entirely or partially as displays on a server. A partial display may preferably comprise in particular the free appointment regions (“blank spaces”) of a client. These blank spaces can be displayed for special periods of time, taking into account filter criteria, or also as a whole for a client (completely) on a server. The control of the information and/or influencing the information supplied lie with the respective client or take place in accordance with default values. The appointment coordination initiated on the part of the master client in this case utilizes the blank space information supplied by the client (or by multiple clients) on the server (or on several network servers) according to the invention. In this case, the peer-to-peer communication can also take place by means of these displays or directly among the clients. This preferred embodiment takes into account a high level of data security and can even reduce the data traffic between the master and clients themselves. This embodiment also allows the master client to make its appointment information (blank spaces) available on the server (transmitted in synchronized or ephemeral form) and the finding of appointments can be evaluated at the server end and only a result is transmitted to the master (appointment options of all possible appointments or a selection thereof).

It would also be possible—by accepting a less favorable utilization of the advantage of data confidentiality (cf. further below in this regard) resulting from avoidance of a server-synchronized calendar (not only the blank spaces but the actual appointments and their content)—to thereby support fully server-synchronized (“cloud-based”) calendars in this way.

In a corresponding preferred variant, at least one client has at least one client module, which is represented as a display on a server, wherein this display comprises some or all of the free appointment regions stored in this client module.

In a method according to the invention for an appointment robot, a master module accesses calendar entries, and an appointment robot is created with an associated parameter set and command set. This appointment robot is transmitted over a data network to one or more client modules. The client modules receive groups and/or lists with possible provisional appointment entries on the master module and evaluates them to determine one or more calendar bookings. An appointment robot having an associated parameter set and command set is received by a master module and calendar entries are accessed and a group and/or list with provisional appointments is generated and transmitted to the master module.

In one embodiment, the master module transmits an appointment booking and/or calendar booking that has been determined to one or more client modules, and an acknowledgment is received by the one or more client modules and the calendar booking is saved.

In one embodiment, an appointment booking and/or a calendar booking is received by a master module from one or more client modules, and the calendar booking is saved and an acknowledgment is sent to the master module.

In one embodiment, calendar entries saved in multiple calendar databanks are accessed by the master module and/or the one or more client modules, wherein the calendar databanks comprise at least one calendar databank of a user assigned to the master module and/or the one or more client modules and a calendar databank for saving provisional appointments.

In one embodiment, calendar entries in a local memory assigned to the master module and/or client module are accessed by the master module and/or by the one or more client modules and/or calendar entries in a memory accessible via a data network.

In one embodiment, an appointment robot having an associated parameter set, groups and/or lists with provisional calendar appointments and/or calendar bookings that have been determined is created by the master module and/or by the one or more client modules in a data format comprising one or more entries in an iCalendar data format.

In one embodiment, data is exchanged between the master module and the one or more client modules according to an Extensible Messaging and Presence Protocol.

In one embodiment, data such as an appointment robot, in particular with an associated parameter set and command set, provisional appointment entries, etc. is secured in a capsule by the master module and/or by the one or more client modules before transmission, this capsule comprising a hash, an electronic signature and/or an electronic encryption and/or the secured capsule is inspected on receipt.

In one embodiment, a parameter set associated with the appointment robot is generated by the master module and/or by the one or more client modules and is transmitted and/or received, this parameter set comprising one or more of the following parameters: calendar date, starting time and ending time, address information of appointment participants, appointment meeting location, appointment title.

In one embodiment, a command set B associated with the appointment robot is generated by the master module and/or by the one or more client modules and is transmitted and/or received. This command set comprises one or more of the following commands: prioritization of information contained in the parameter set, obligatory specifications regarding information contained in the parameter set, criteria comprising query intervals to ascertain groups and/or lists with free appointments.

A master according to the invention for an appointment robot comprises a master module, which is provided for accessing calendar entries and for generating an appointment robot having a parameter set associated therewith and with a command set, which are secured in a capsule and are to be transmitted over a data network to one or more client modules and for transmission over a data network to one or more client modules and for receiving groups and/or lists with provisional appointment entries from the client modules and for evaluating them to ascertain one or more calendar bookings.

In one embodiment of the master, a graphical user interface is set up to display simultaneously the calendar entries of a user of the master in a first calendar and provisional appointment entries in a second calendar, wherein these calendars are aligned with one another in the time axis.

A client for an appointment robot according to the invention comprises a client module, which is provided to receive an appointment robot having the parameter set and the command set associated with it, which are secured in a capsule, by a master module and to access calendar entries and to generate a group and/or a list with provisional appointments and to transmit it to the master module.

In one embodiment of the client, a graphical user interface is set up to display calendar entries by a user of the client and provisional appointment entries at the same time, in particular by displaying them on calendars shown side by side and aligned with one another with regard to the time axis.

In one embodiment of the client, an input gate is provided to receive an appointment robot having the associated parameter set and command set, which are secured in a capsule, and to check the security elements and to review the parameter set as well as the command set for maintenance of a security guideline.

In one embodiment of the client, an output gate is provided to review a group and/or list with provisional appointments for whether a security guideline has been followed.

### BRIEF DESCRIPTION OF THE DRAWINGS

The invention will now be explained below on the basis of exemplary embodiments in conjunction with the drawings, in which:

FIG. 1a shows schematically a system comprising a master module and a plurality of client modules;

FIG. 1b shows schematically a system comprising a master module and a plurality of client modules, including a client module with a representation on a server;

FIG. 2 shows schematically an appointment robot with the associated parameter set and command set;

FIG. 3 shows schematically a client module with an input gate and an output gate;

FIG. 4 shows schematically a graphical user interface for a master module;

and

FIG. 5 shows schematically a graphical user interface for a client module.

### DETAILED DESCRIPTION OF THE PREFERRED EMBODIMENTS

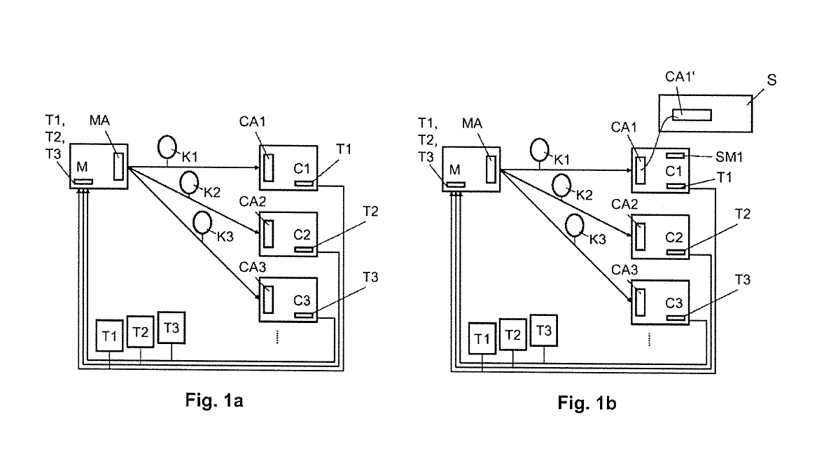

FIG. 1a shows a system with a master module MA and a plurality of client modules CA1, CA2, CA3. The master module MA is contained in a mobile device (smartphone, handheld device, etc.) designated as the master M. The client modules CA1, CA2 CA3 are each contained in mobile devices (likewise smartphones, handheld devices, etc.) each designated as clients C1, C2, C3. The master module MA and the client modules CA1, CA2 CA3 are embodied in particular as ASICs or as software applications or a combination of these two variants. In a preferred variant, the master module MA and/or the client modules CA1, CA2, CA3 are installed as software applications in the module devices M, C1, C2, C3 which are shown schematically in FIG. 1a and are embodied on a processor there. In a preferred variant, the master module MA and/or the client modules CA1, CA2, CA3 are embodied as hardware components, for example, as ASICs (ASIC: application-specific integrated circuit), which are used in the mobile devices M, C1, C2, C3. The mobile devices M, C1, C2, C3 are embodied as smartphones, mobile telephones, tablets or as armband displays, etc. A mobile device M, C1, C2, C3 comprises communication interfaces, user interfaces, microprocessors and other electronic circuits. Communication interfaces comprise a mobile wireless interface or an interface to a WLAN (wireless local area network) or some other communication network link. User interfaces comprise a touchscreen, a display screen and/or a pointer device and/or a keyboard.

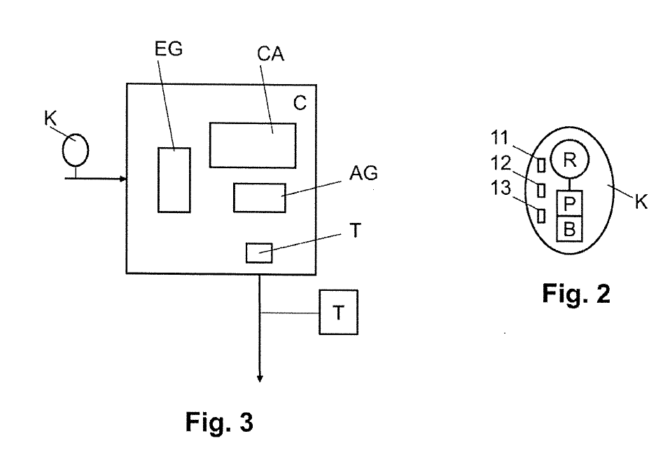

With the master module MA contained in the master M and the client modules CA1, CA2, CA3 contained in the clients C1, C2, C3 the functions of the system that are explained in detail below are carried out for an appointment robot, wherein these functions are controlled by the master module MA and the client modules CA1, CA2, CA3. In one variant, the master module MA and/or the client modules CA1, CA2, CA3 are made available in a software store (so-called app store) as downloadable, i.e., installable, apps, comprising either a master module, a client module or both. This step is omitted if the respective modules are preinstalled as ASICs or software applications in the mobile device M, C1, C2, C3. In the case of a master module MA and/or client modules CA1, CA2, CA3 embodied as an app, these can be protected from manipulation by security systems in a traditional manner. As already mentioned, the master module MA and one client each CA1, CA2, CA3 are combined in a single module, i.e., the functions of the master module MA and of the client modules CA1, CA2, CA3 that have been described are made available by a uniform app, which behaves like the master module MA on the master M and behaves like the client modules CA1, CA2, CA3 on the clients C1, C2, C3. The client modules CA1, CA2, CA3 are embodied here as identical modules, which are individualized by settings of the clients C1, C2, C3 such as an IMEI (International Mobile Equipment Identity), user information, telephone numbers, etc. In the system for an appointment robot illustrated in FIG. 1a, an appointment request is not transmitted from a master M to clients C1, C2, C3 as a mere information unit comprising an iCalendar object, for example, as in the prior art, but instead the appointment synchronization is based on the appointment robot R, which is diagramed schematically in FIG. 2 and is made available to the clients C1, C2, C3. As diagramed schematically in FIG. 2, a parameter set P and a command set B are contained in the appointment robot R. In the present exemplary embodiment, the appointment robot R, the parameter set P and/or the command set B are encapsulated in a capsule K, which is verified by a hash value 11 and/or an electronic signature 12 and is made available to the clients C1, C2, C3. The capsule K can optionally be secured additionally by an electronic encryption 13. The hash value 11, the electronic signature 12 and the electronic encryption 13 form security elements of the capsule K. In addition to the security elements 11, 12, 13, the capsule K or the appointment robot R includes a cell phone number, an IMEI (International Mobile Equipment Identity), an MSISDN (Mobile Subscriber Integrated Services Digital Network Number), an email address and/or other information as information about a manufacturer or a sender. Preferably at least some of this data, in particular a telephone number (or its substitute) is contained as an identifier in a capsule header. The capsule header is unencrypted in this case.

In the present case, the master M generates a capsule K1 which is shown schematically in FIG. 1a and can be transmitted and/or made available over traditional data networks (e.g., a TCP/IP network) to the clients C1, C2, C3. In different embodiments, the capsule K1 can be formed by a command set B, which is already present with a client and a parameter set P, which is transmitted by the master M (hash value, signature and encryption can be secured in a known way for the capsule by analogy). The advantage of such a division lies in the lower data volume that must be sent by the master M to the clients C1, C2, C3. In another embodiment of the invention, as represented schematically by the capsules K2, K3 in FIG. 1a, the parameter set P and the command set B for each client C1, C2, C3 should be different, for example, when the appointment synchronization for the clients C1, C2, C3 does not presuppose completely identical parameters. Again with this embodiment, the capsules K1 K2, K3 should be formed by the client C1, C2, C3 only as needed.

On receiving a capsule K1 K2, K3 at a client C1, C2, C3 the manufacturer or the sender of the capsule K1 K2, K3 is checked on the respective client C1, C2, C3 in particular. Furthermore, the security elements 11, 12, 13 of the capsule K1 K2, K3 are evaluated, wherein a check of the signature and/or of a hash value and/or of a decryption is performed. If the manufacturer or sender is known and the evaluation of the security elements is successful, then the appointment robot R as well as the parameter set P and command set B associated with it are made available to the respective client C1, C2, C3.

FIG. 1b shows an embodiment of the system according to the invention, which largely corresponds to FIG. 1a but has a client C, in which the client module CA1 is represented as a representation CA1′ on a server S. This representation CA1′ here preferably contains only parts of the free appointment ranges saved on this client module CA1. However, all free appointment ranges (i.e., all “blank spots” in the calendar of client module C1) can also be synchronized with the CA1′ representation as needed.

These blank spots are preferably subsets of all free appointments of the client module C1 in the present example—again for reasons of data security—i.e., they comprise only one or more special predefined periods of time (e.g., 2 months or a year into the future) or they are determined on the basis of predetermined or dynamic fine filter criteria (e.g., no more than three half days per week, not before 7:00 a.m. and/or “never on Wednesday morning,” etc.). The filter criteria can be modified and processed by the user in client C, starring from the default values. In a refinement of this approach, the filter criteria can be determined by the client in a self-learning process (e.g., if appointments on Thursdays are always cancelled by the user, etc.). To do so, the client has a self-learning module SM1, which has a self-learning logic unit and/or a corresponding module and memory.

The appointment coordination and/or the appointment robot initiated on the part of the master client makes use of information made available in the representation CA1′ in this case. Furthermore, it is possible for all clients C1, C2, C3 and also the master client to supply a corresponding representation on the server S (or network servers). Synchronization of appointments otherwise takes place according to the invention by analogy with that in FIG. 1a and/or the method described below.

In further special embodiment variants, in particular in a bandwidth which is available to the master M only to a limited extent, the parameter set P and/or the capsule header may contain forwarding information. In this way, only one capsule K1 can be sent by the master M and is then received by the client C1, for example, and is forwarded by the latter to the additional clients C2 and C3. Forwarding by the client C1 is enabled, limited or denied entirely on an individual basis through authorization settings, wherein a corresponding message is preferably issued to the original sender, namely the master M in this case, so that another transmission process can be provided by way of an alternative client C2, etc. Similarly, instead of forwarding via a client, a capsule distribution can be enabled, preferably to multiple clients C1, C2, C3 and/or up to Cn through a corresponding network resource (for example, a communication server).

The parameter set P comprises data which is preferably structured here in an iCalendar data format. The command set B here contains command definitions formulated in a machine-interpretable language. Standard parameters or standard commands may be stored in tables saved in the master M and the clients C1, C2, C3 so only the information of the respective table row ID is necessary for transmission of a respective standard parameter or standard command in the parameter set P or in the command set B. Therefore, the data volume to be transmitted can be reduced.

The data stored in the parameter set P in an iCalendar data format includes a list of information components. The components relate to an event, a to-do list, a journal entry, time zone information, free time and/or booked time or an alarm time. The list entries with the components are arranged in rows in the present case and may have entries such as UI:, DTSTAMP:, ORGANIZER:, DTSTART:, DTEND: or SUMMARY:. Alternatively, structured markup languages can be used for compilation of the parameter set P.

The parameter set P comprises corresponding data for one or more appointments about which there have been queries and which include, for example, calendar dates, starting times, ending times, appointment durations, data about the content of the appointment, the urgency of the appointment, data with location information, data about appointment participants, etc.

The commands formulated in a machine-interpretable language in the command set B are provided to define requests and/or codes, which are to be performed on and/or can be interpreted by a client C1, C2, C3. The requests preferably make it possible to discover free appointments in a calendar, such as, for example, for finding free appointments of a certain duration, on certain days, within certain intervals of time, etc. For example, coding to determine all free half-hour appointments for a morning during the next four work weeks may be defined. A corresponding coding may additionally include, for example, limitations such as “return no more than seven appointment options.” Due to the commands formulated in a machine-interpretable language, requests can be summarized in a very flexible manner. The command set B may comprise source code, script commands or binary code, which can be executed directly by a compiler, an interpreter or a processor in the receiving client C1, C2, C3. This makes it possible to carry out very efficient and flexible commands. Here again, as an alternative, a special markup language may be provided for the command set.

The command set B may comprise instructions, which parameterize a business logic, i.e., for example, instructions pertaining to the prioritization of normal office hours with respect to marginal times, instructions pertaining to the prioritization of localities or geographic locations, flexible (fuzzy) parameters (such as codings, e.g., “preferably in marginal times”), etc.

Thus, because of the transmitted appointment robot R, the client modules CA1, CA2, CA3 execute defined functions on the respective client C1, C2, C3 in particular as defined according to the parameter set P and command set B associated with the appointment robot R. Unlike traditional approaches to appointment coordination, transmission of the appointment robot makes it possible to avoid a central calendar server in preferred embodiments, on which the calendars of all clients would have to be copied and/or synchronized. This is an important technical advantage in particular because of the sensitive data contained in calendars.

The parameter set P and the command set B are created on the basis of an appointment request that has been specified, i.e., input, by a user on the master M. Such an appointment request comprises data with information pertaining to desired or required appointment participants, date information, time information, location information, etc. For example, the user can enter the item “meeting of business management for 4 hours next 2 weeks, preferably in the afternoon” interactively on the master M. The portions “meeting of business management” (participants) and “4 hours” (duration) are assigned to the parameter set P. The portions “next 4 weeks . . . ” (interval during which appointments are to be sought) and “. . . preferably in the afternoon” are assigned to command set B. The appointment participants required for the appointment request as well as their clients C1, C2, C3 are determined on the basis of saved contact information, for example. The location of the meetings and/or additional information required to set the appointment is/are derived, for example, from saved standard values. Contact data and/or standard values can be stored locally in a user-specific manner in the master M or in a central server, such as an Internet server, for example. This additional information (location, additional people, etc.) is optional in the appointment request step, so it may or may not be included in the capsule. This information is not usually necessary until the subsequent step of setting an appointment.

In creating the parameter set P and the command set B, local calendars of the client or, alternatively, Internet calendars (i.e., calendars released on the Internet by a server, for example) are accessed, in particular such calendars that are assigned to the user of the master M. This information is accessed here in the traditional manner via an API (application programming interface), which is made available by the operating system of the master M. In a previous example pertaining to the “meeting of the business management,” suggested appointments are assembled from the local calendars, Internet calendars, etc. of the user and are associated as parameter set P and command set B with an appointment robot R, which is packed into a capsule K and made available to one or more clients C1, C2, C3. In creation of the appointment robot, the corresponding provisional appointments TM are entered into a calendar for provisional appointments on the master M (if appointment times are already included in the parameter set P) and are thus earmarked.

As described above, because of the appointment robot R that is made available, the parameter set P and the command set B associated with the appointment robot R are accessed by the respective client module CA1, CA2, CA3 on the clients C1, C2, C3. The client module CA1, CA2, CA3 also accesses local calendars and/or Internet calendars, etc., which are assigned to the respective user of the client C1, C2, C3 in particular. Access to the calendars assigned to the clients C1, C2, C3 also takes place via API. The client module CA1, CA2, CA3 creates provisional appointments T1, T2, T3 by taking into account the parameters P, the command set B as well as local calendars, Internet calendars, etc., for the respective clients C1, C2, C3 and these provisional appointments are entered into a calendar of provisional appointments that can be accessed by the client C1, C2, C3 and are thereby earmarked. For the sake of illustration, it should be pointed out here that these provisional appointments may be individual appointments or time appointments, which include several possible appointment options for a client C1, C2, C3.

The provisional appointments T1, T2, T3 are transmitted to the master M, where they are evaluated and an appointment is set and/or an appointment booking or calendar booking is determined and transmitted to the clients C1, C2, C3. The appointment booking and/or calendar booking (including a provisional appointment and/or an appointment within the possible periods of time of the provisional appointments received by the master) is entered into a definitive calendar (a local calendar or alternatively an Internet calendar) of the master M as well as of the clients C1, C2, C3. This entry is acknowledged as needed by the clients C1, C2, C3 with respect to the master M (or vice versa). After entering the appointment booking and/or calendar booking, the provisional appointments T1, T2, T3 corresponding to the respective appointment requests are deactivated, blanked out or deleted in the calendar with the provisional appointments on the master M and the clients C1, C2, C3. This is made possible by issuing corresponding IDs in requesting an appointment and/or setting an appointment.

The following table shows provisional appointments T1, T2, T3 of clients C1, C2, C3 which are evaluated with respect to provisional appointments TM of the master M. The provisional appointments TM, T1, T2, T3 are listed in a table shown below and the matching appointments for the master M and the clients C1, C2, C3 are ascertained.

| Appointment | TM | T1 | T2 | T3 |
|---|---|---|---|---|
| 1 Mo 8-9 | X | | x | |
| 2 Tu 12-13 | X | x | x | X |
| 3 We 14-16 | X | x | | |
| 4 Fr 8-9 | X | x | x | X |

The appointment 2 Tu 12-13 and the appointment 4 Fr 8-9 are entered as provisional appointments for the master M as well as for all the clients C1, C2, C3 and may be considered for an appointment booking and/or a calendar booking. Because of an additional rule to always book the earliest possible appointment, the master M would book the appointment 2 Tu 12-13. In one variant, if such an additional rule is not configured on the master M, the two appointments 2 Tu 12-13 and 4 Fr 8-9 would be displayed for the user of the master M. The appointment booking may of course claim the entire appointment of these individual provisional appointments or only a portion of the time for that appointment.

As explained here, creating an appointment entry for a master M and multiple clients C1, C2, C3 requires only manual input of an appointment request on the master M. Then the determination and entry of an appointment booking and/or a calendar booking on the master M and the clients C1, C2, C3 take place in a fully automatic process because of the appointment robot R. In this automatic process, a manual confirmation or a manual adjustment by a user of the master M or a user of a client C1, C2, C3 may optionally be provided in one or more steps. Thus before they are sent, provisional appointments T1, T2, T3 may be displayed on the respective client C1, C2, C3 and the user may be given an opportunity to modify, delete, etc. provisional appointments T1, T2, T3. Before the capsules K1 K2, K3 and/or the corresponding appointment robots R are made available, a manual check, revision, etc. by the user of the master M may be provided. The acknowledgment of an appointment booking and/or calendar booking by the clients C1, C2, C3 is preferably made dependent on manual input by the user of the respective client C1, C2, C3. Such manual intervention is optional but may serve, for example, to keep the user of the appointment synchronization system better informed or to keep their private sphere optimally preserved. Such manual entries are preferred in order to conform to existing security guidelines in particular with regard to access to and storage of calendar entries.

FIG. 3 shows schematically a client C, which has a client module CA with an input gate EG and an output gate AG. The input gate EG is provided to perform a check of a capsule K or of robot R, which was made available to the client C. The output gate AG is provided to perform a check of provisional appointments T, which are provided for transmission to a master M. In one variant, the input gate EG and the output gate AG are contained in the client module CA.

The input gate EG is embodied, so that in a first step, on receipt of a capsule K or a robot R, the sender, the manufacturer and the security elements, which are preferably contained at least partially in the capsule header, are checked. To do so, the input gate EG performs a comparison of corresponding data and carries out corresponding control functions. If this check is successful, then in a second step, the input gate EG checks the parameter set P and the command set B according to a three-step security guideline, which is preferred here. In a first security step F1, the parameter set P and the command set B are not checked further and are released directly to the client module CA for further processing. In a second security step F2, a check is performed for selected senders or manufacturers of the appointment robot R to ascertain whether admissible accesses to calendar data have occurred via the parameter set P or the command set B. The selected senders pertain to senders not known to the user of the client C, i.e., not contained in a contact databank of client C. The selected senders may also pertain to senders that are marked accordingly in a contact databank of the client C. In a third security step F3, a check is performed for all the senders of the appointment robot R and/or of the capsule K to ascertain whether inadmissible accesses to calendar data have occurred due to the parameter set P or the command set B. The security steps F1, F2, F3 may be configured by the user of the client C.

The definition of inadmissible access to calendar data is based on standard values (default values), which the user of client C can set in accordance with his own needs. The user of client C can therefore define the fact that access to calendar data over a period of time longer than the next 8 weeks, for example, is inadmissible. The user of client C can also define that appointment requests, which could result in a large number of more than 20 results, for example, are inadmissible. In special embodiment variants of the invention, such restrictions and/or limitations may also be provided directly in the corresponding code to suppress inadmissible inquiries here by an appointment robot.

If inadmissible access to client C is detected, a message is displayed for the user of client C, and the user is given the option of nevertheless carrying out the inadmissible access, changing and restricting access or refusing access.

Output gate AG is embodied so that a check is performed of the provisional appointments T determined. The check likewise takes place here preferably according to a three-step security guideline. In a first security step E1, the provisional appointments are not checked further and are released immediately for transmission to the respective master M. the provisional appointments for selected masters M are checked in a second security step E2. The selected masters M are defined according to standard values or according to specifications by a user of client C. Provisional appointments T are transmitted to a master M, which is not yet known, for example, until after a check that enables user intervention. In a third security step E3, a check of the provisional appointments is performed for all masters M.

A check of provisional appointments T is in turn based on standard values, which the user of client C can adjust according to his own specifications. The user of client C can define that only a maximum number of, for example, provisional appointments can be transmitted to a master M. For selected masters M, the user can specify that only provisional appointments pertaining to a certain location, for example, are transmitted.

If the check of the provisional appointments T fails, this is displayed for the user of the client C, who is given an opportunity to delete these provisional appointments manually or to change them before the provisional appointments are released.

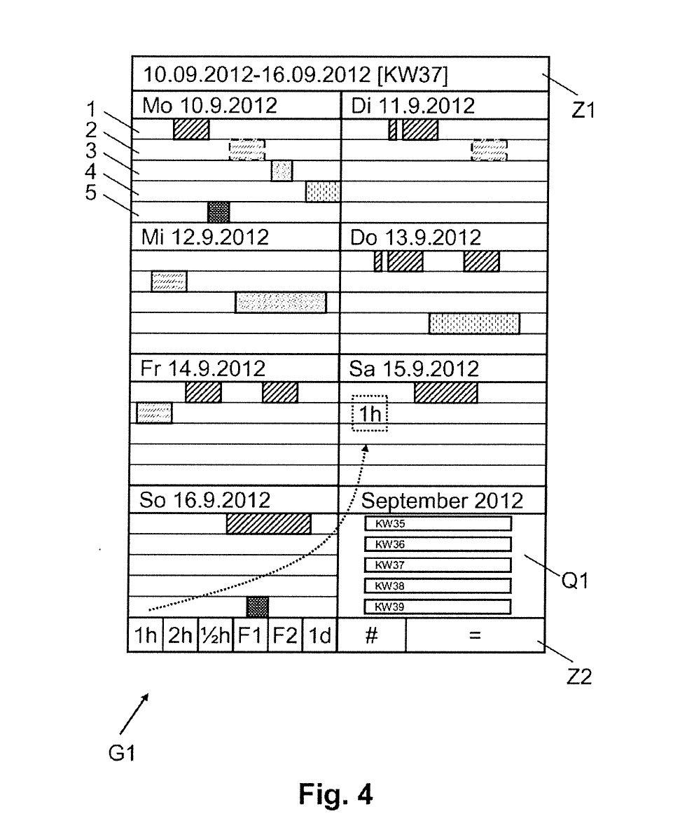

FIG. 4 shows a graphical user interface G1 for display and input of appointments on the master M. The graphical user interface G1 is preferably provided for a touch-sensitive screen such as a touchscreen of the master M. The displays of the corresponding clients are designed accordingly.

A weekly view is displayed on the graphical user interface G1 here, namely calendar week 37 (CW37) in the year 2012 in this specific example. The graphical user interface G1 has a title row Z1 with the information about the respective calendar week, seven fields for the days of the week arranged in four rows and two columns, one field for a monthly view Q1 arranged in the fourth row of the days of the week and one footer line Z2 with control elements.

For each day of the week, multiple calendars 1, 2, 3, 4, 5 are shown at the same time. In FIG. 4 the multiple calendars 1, 2, 3, 4, 5 are displayed as successive rows in the respective days of the week. The special feature of this representation is that a calendar matrix, such as that described in greater detail below, is displayed in a novel manner for days of the week. The appointments of the respective calendars 1, 2, 3, 4, 5 are preferably saved in multiple local calendars of the master M. The multiple calendars of the calendar matrix are shown in various ways by using, e.g., different hatching, colors, etc. The lengths of the calendars 1, 2, 3, 4, 5, which are shown as horizontal rows, correspond to an interval of time such as office hours, expanded office hours, etc. of the respective day. The office hours may be defined as 8:00 a.m. to 5:00 p.m., for example, whereas the expanded office hours mentioned above are defined as 7 a.m. to 7 p.m., for example. The lengths of the horizontal rows of the calendars 1, 2, 3, 4, 5 shown here may correspond to another interval of time. The appointment entries in each of these calendars 1, 2, 3, 4, 5 of the calendar matrix are shown chronologically and proportionally within the respective calendar row, so that the calendars are aligned with one another with respect to the time axis.

An important special feature of the embodiment shown here lies in the fact that a separate calendar for definitive appointments and for provisional appointments is provided in each daily calendar matrix. This permits efficient, automated and understandable (if visible at all to the user) automated processes of writing to the respective appointment robots. The appointment robot can transfer or store a possible appointment identified by the master to or in the definitive calendar or even the calendar for provisional appointments by means of an appointment booking (on the master end or on the client end). For the user interface according to this embodiment variant, this division into two separate calendars is a very important advantage of the invention.

A first calendar 1 is thus provided for display and input of saved definitive appointments of the user of the master M. To enter an appointment of one hour, the user preferably drags a control field 1h of the footer row 1 and drops it in the respective location of the first calendar 1 displayed. Then a dialog box opens, so that it is possible to deal with detailed appointment information such as the title, location, etc. With a longer touch lasting more than 1 second (without movement), for example, the corresponding standard appointment can be modified (for example, by “customer meeting in meeting room”) and preferably supported by a so-called wizard, which provides the input of the parameter set P and the command set B, then an appointment can be created in a very flexible and efficient manner by means of drag and drop (after the wizard has finished). To modify an appointment in the first calendar 1, the user touches the corresponding appointment, whereupon a window opens to modify appointment entries, such as the time, the location, etc. To delete an appointment, the user drags the respective appointment out of the calendar display onto a delete button, for example. Appointments can be managed by another method. However, it is an advantage to be able to create appointments by drag and drop using control fields in the footer line.

FIG. 4 shows a separate second calendar 2 in the respective daily calendar matrix, which is provided for display and input of provisional appointments of the user of the master M. The provisional appointments may be subdivided into provisional appointments, for which an appointment survey is being processed, and provisional appointments for which a new appointment survey is to be started. For differentiation, provisional appointments belonging to a pending appointment survey are shown with dotted lines, for example, or in a first color whereas provisional appointments belonging to a new appointment survey are shown with solid lines or in a second color, for example. In the example shown in FIG. 4, a provisional appointment belonging to a pending appointment survey is entered on both Monday and Tuesday whereas provisional appointments belonging to a new appointment survey are entered on Wednesday and Friday. To add another provisional appointment with a duration of one hour to the appointment survey, the control element with the designation “1h” can be dragged from the footer line Z2 to the respective location in the second calendar 2 and dropped there, as shown schematically in FIG. 4, for example. In the example shown in FIG. 4, a provisional appointment with a duration of one hour for Saturday is detected in this way at the respective point in time. The appointment is detected as done for the process described for the first calendar 1.

The third calendar 3, which is shown in FIG. 4, the fourth calendar 4 and the fifth calendar 5 contain appointments, which are subscribed to, for example, by a different client calendar or even an Internet calendar. These appointments can be ordered, for example, by colleagues at work, family members, associations, concert promoters, etc. and displayed on the graphical user interface G1. Thus, for example, the appointments of a work colleague can be displayed in the third calendar 3, the appointments of a person's life partner can be displayed in the fourth calendar 4, and the appointments of a lecture cycle can be displayed in the fifth calendar 5. The user is informed immediately about which times are available for entering additional appointments by simultaneous display of the calendars 1, 2, 3, 4 and 5. For example, with a cancellation with short notice of an appointment entered in the first calendar 1, the user is thus informed immediately whether participation in a lecture cycle, a group meeting, etc. may be considered instead.

This simultaneous display of a first calendar 1, which is coordinated with segment entries for appointments and for display in chronological order with definitive appointments, a separate second calendar 2 with provisional appointments and with a number n of subscribed (integrated) outside calendars forms a calendar matrix, which can be supplemented by additional calendars that are displayed. In each calendar, a plurality of individual appointments can be determined. The respective calendars 1-5 are aligned with one another, so that they match chronologically and permit a direct visual comparison. Within each calendar matrix, a selectable sequence and/or a scrolling mechanism is/are preferably provided, wherein the first and second calendars 1, 2 preferably remain permanently overlaid. This calendar matrix allows automated writing operations within the calendar by the respective appointment robots in a manner that is highly dynamic and nevertheless is visually recognizable by a user. The calendar matrices here are each shown as a daily calendar matrix. Accordingly a, calendar matrix for a single day, a month, a week or a period may be provided. It is important here that each calendar can be displayed separately, that write authorizations can be defined clearly for each calendar and that the user has his (local) first and second calendars 1, 2 available in particular.

With such a graphical user interface G1 the user of the master M has a complete overview of all appointments that can be comprehended rapidly and must be taken into account when creating an appointment survey. Instead of five calendars 1, 2, 3, 4, 5, more or fewer calendars can also be displayed at the same time. Preferably at least the first calendar 1 with the appointments of the user and the second calendar 2 with the provisional appointments of the user are shown (fixedly) at the same time.

Furthermore, the graphical user interface G1 for example, is also provided, so that control elements from the footer row Z2 can be dragged to a single day of the displayed week, to calendar weeks displayed in the monthly display Q1, the month displayed, etc. to start a corresponding appointment survey. For example, a control element marked with the label F1 in the footer line Z2 may be provided for starting an appointment survey for a spontaneous meeting after work, wherein a certain participant group, for example, a group of friends, is included in the appointment survey by dragging and dropping the control element at a date, a time, etc., wherein a robot R is created and made available to the respective clients C1, C2, C3. Instead of that, the control element with the label F1 may also be provided for starting an appointment survey for a meeting of 2 hours by dragging and dropping the control element at a calendar week displayed in the monthly view for the respective calendar week, wherein a robot R is created and the respective clients C1, C2, C3 are made available to agree upon an appointment booking and/or a calendar booking with members of a work group. The properties of the elements displayed in the footer line Z2 can be adjusted with the control element designated with the label#, for example, wherein, when this control element is touched, a mask opens to define in particular the participants of the appointment and the duration. Furthermore, the footer line Z2 has a control element, which is designated with the label=and is provided for quickly starting a repeating appointment survey, i.e., for a work group an appointment survey for the next possible appointment of a 30-minute meeting, for example, to be able to quickly discuss an urgent problem relating to the work group.

Based on the appointment survey that has been initiated, a parameter set P and a command set B are created on the master M and/or by the master application and associated with an appointment robot R. Before these are made available to one or more clients C1, C2, C3 as described above, a capsule K (wholly or partially encrypted) is optionally formed, depending on the settings or specifications. As described above, in one variant, an appointment booking and/or a calendar booking is performed in accordance with the appointment survey because of the appointment robot R and the associated parameter set B as well as the command set B in a fully automatic process in cooperation with calendars defined on the clients C1, C2, C3 and these bookings are entered into the respective calendar of the master M and of the clients C1, C2, C3. While determining the appointment booking and/or calendar booking for the appointment survey, provisional appointments are preferably entered temporarily in the respective calendar of the master client M as well as the clients C1, C2, C3.

Various manual steps may be provided in determining the appointment booking and/or calendar booking corresponding to the appointment survey, in particular to inform users based on messages to be confirmed and to offer users the opportunity for making manual adjustments, changing appointment surveys for a short period of time, etc.

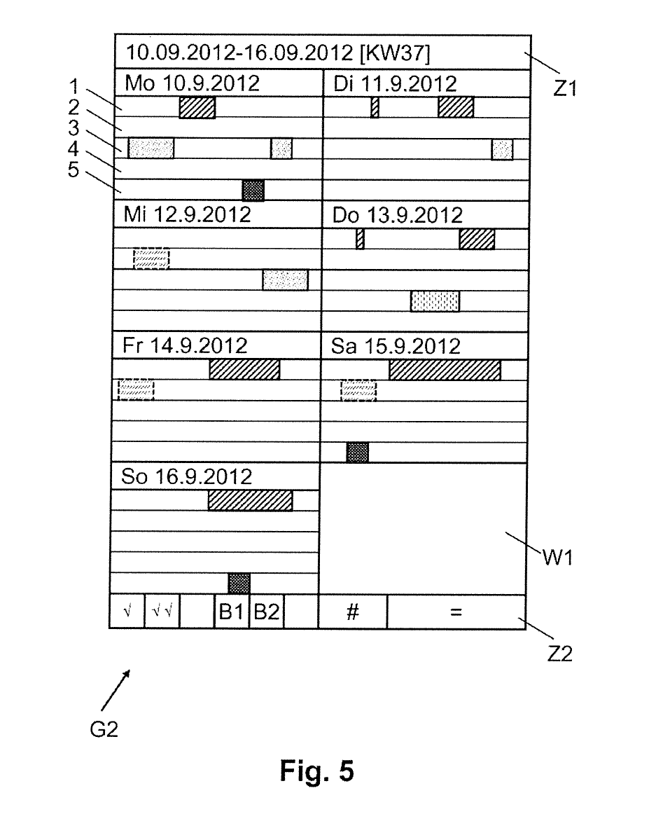

After an appointment robot R as well as the parameter set P and the command set B associated therewith on a client C1, C2, C3 have been evaluated and provisional appointments T1, T2, T3 have thus been determined, the provisional appointments T1, T2, T3 are displayed schematically for the user as shown in FIG. 5, for example, and displayed in a graphical user interface G2 for display of provisional appointments. This user interface G2 is constructed like the user interface G1 described above for input of an appointment survey on a master M. As an alternative to this user interface G2, the control elements of client C1, C2, C3 and master M can be combined in a uniform footer row together (footer row of master and client are the same in this case). Again the appointments of the user for the days of the week are displayed in a first calendar 1, the provisional appointments are displayed in a calendar 2 with the provisional appointments and additional local or remote calendars 3, 4, 5. Before the user confirms the provisional appointments, they are displayed in the calendar 2 with the provisional appointments, for example, as a flashing display or with a different mark. As shown schematically in FIG. 5, other control elements are arranged in the footer row Z2 than the control elements described in conjunction with the input of an appointment survey on a master M. The footer row Z2 of the user interface G2 for display of provisional appointments comprises a control element √ for confirmation of individual or multiple provisional appointments according to a predefined setting, a control element √√ for confirmation of all provisional appointments, control elements B1, B2 for a user-specific confirmation of provisional appointments, for example, a confirmation of all provisional appointments which do not conflict with an appointment on the calendar K1 with definitive appointments contained therein (which were optionally detected manually or were not taken into account in determining the provisional appointments) or a confirmation of all provisional appointments which do not conflict with the third calendar 3 or the fourth calendar 4 (in the example shown in FIG. 5, this is “no appointment”). Furthermore, a control element# is provided to perform user settings, for example, to ascertain the user-specific confirmations B1, B2 and a control element=to accept the provisional appointments thereby determined in a standard sequence, wherein the standard sequence may be configured to discard certain provisional appointments such as appointments on the weekend.

Instead of a monthly view Q1, a function surface W1 may be provided at the appropriate location in the graphical user interface G1 G2. In the preferred variant here, the calendar 1 with the appointments of a user and the calendar 2 with the provisional appointments are shown one above the other and are displayed with colored or other graphical differentiating features.

In a preferred embodiment the evaluation of the parameter set P and the command set B takes place with respect to the calendars of the user of a client C1, C2, C3 in such a way that there is no conflict between the calendar 1 with the appointments of the user and the calendar 2 with the provisional appointments. In another variant, in determining the provisional appointments, any trips between geographic locations pertaining to the appointments are automatically taken into account.

The data transmission between the master M and the clients C1, C2, C3 takes place over a data network such as the TCP/IP based Internet. In one possible embodiment the data transmission is based on an Extensible Messaging and Presence Protocol XMPP according to an Internet standard for XML routing published by the IETF in RFC 6120-6122 as well as 3922, 3923 (XML: Extensible Markup Language). The robot R, the parameter set P associated therewith and the command set B, optionally the capsule K, provisional appointments T1, T2, T3, which are transmitted from the clients C1, C2, C3 to the master M as well as an appointment booking and/or calendar booking are preferably structured and formulated in an iCal and/or XML data format.

In another variant the master module M and/or one or more client modules C1, C2, C3 is embodied as an application that can be installed on a personal computer (PC), notebook, etc. and can be run there or as a hardware module that can be inserted into such a device or as a mixture of these two variants.

Additional special embodiments are derived from one or more embodiments depicted below.

In a preferred variant of the system for an appointment robot R, the master module MA and/or the one or more client modules CA1, CA2, CA3 is/are provided to access calendar entries in a local memory assigned to the master module MA and/or to the client modules CA1, CA2, CA3 and/or to access calendar entries in a memory that can be accessed via a data network.

In a preferred variant of the system for an appointment robot R, the master module MA and/or the one or more client modules CA1, CA2, CA3 are provided to create the parameter set P and command set B associated with the appointment robot R, the groups with provisional calendar appointments T1, T2, T3 and/or a calendar entry that has been detected in a data format comprising one or more entries in an iCalendar data format.

In one variant of the system for an appointment robot R, the master module MA and/or the one or more client modules CA1, CA2, CA3 are provided for exchanging data between a master module MA and the one or more client modules CA1, CA2, CA3 according to an Extensible Messaging and Presence Protocol.

In a preferred variant of the system for an appointment robot R, the master module MA and/or the one or more client modules CA1, CA2, CA3 is/are provided to create a parameter set P associated with the appointment robot R and to transmit it and/or receive it, comprising one or more of the following parameters: calendar date, starting time and ending time, address information of appointment participants, appointment meeting time, appointment title.

In a preferred variant of the method for an appointment robot, the master module MA and/or the one or more client modules CA1, CA2, CA3 can access calendar entries in a local memory assigned to the master module MA and/or to the client module CA1, CA2, CA3 and/or calendar entries in a memory that can be accessed over a data network.

In a preferred variant of the method for an appointment robot R, the master module creates an appointment robot having an associated parameter set P, groups with provisional calendar appointments and/or calendar bookings that have been ascertained in a data format comprising one or more entries in an iCalendar data format.

In one variant of the method for an appointment robot R, data is exchanged between the master module MA and the one or more client modules CA1, CA2, CA3 in accordance with an Extensible Messaging and Presence Protocol.

In a preferred variant of the method for an appointment robot R, a parameter set P associated with the appointment robot is created and transmitted and/or received by the master module MA and/or by the one or more client modules CA1, CA2, CA3, this appointment robot comprising one or more of the following parameters: calendar date, starting time and ending time, address information of appointment participants, appointment meeting location and appointment title.

In a preferred variant of a client for an appointment robot, an input gate EG is provided to receive an appointment robot R with an associated parameter set P and command set B, which are secured in a capsule K, and to check the security elements 11, 12, 13 and to check the parameter set P and the command set B for whether they conform to a security guideline E1, E2, E3.

In a preferred variant of a client for an appointment robot, an output gate is provided to check a group with provisional appointments for whether they conform to a security guideline.

1. A system for an appointment robot (R), the system comprising a master module (MA) and one or more client modules (CA1, CA2, CA3), wherein
the master module (MA) is provided to access calendar entries and to generate an appointment robot (R) having a parameter set (P) and a command set (B) associated therewith and to transmit them over a data network to one or more client modules (CA1, CA2, CA3), and to receive groups with provisional appointment entries (T1, T2, T3) from the client modules (CA1, CA2, CA3) and to evaluate them to ascertain one or more calendar bookings, and
the one or more client modules (CA1, CA2, CA3) are provided to receive an appointment robot (R) having a parameter set (P) and a command set (B) associated therewith from a master module (MA) and to access calendar entries and to generate a group of provisional appointments (T1, T2, T3) and to transmit them to the master module (MA).

2. The system according to claim 1, wherein the master module (MA) is provided to transmit a calendar booking that is ascertained to one or more client modules (CA1, CA2, CA3) and to receive an acknowledgment from the one or more client modules (CA1, CA2, CA3) and to save the calendar booking.

3. The system according to claim 1 wherein the one or more client modules (CA1, CA2, CA3) are provided, the latter to receive a calendar booking from a master module (MA), to save the calendar booking and to transmit an acknowledgment to the master module (MA).

4. The system according to claim 1 wherein the master module (MA) and/or the one or more client modules (CA1, CA2, CA3) are provided to access calendar entries saved in a plurality of calendar databanks, wherein the calendar databanks comprise at least one calendar databank of a user assigned to the master module (MA) and/or the client module (CA1, CA2, CA3) and further comprise a calendar databank for saving provisional appointments (T1, T2, T3).

5. The system according to claim 1 and further with a capsule (K) with security elements, the security elements including a hash, an electronic signature and/or an electronic encryption, the master module (MA) and/or the one or more client modules (CA1, CA2, CA3) are provided to secure data with an appointment robot (R) with an associated parameter set (P) and a command set (B), to check provisional appointment entries (T1, T2, T3) before transmission in a capsule (K) and to check the secured capsule (K) on receipt.

6. The system according to claim 1 wherein the master module (MA) and/or the one or more client modules (CA1, CA2, CA3) are provided to create a command set (B) associated with the appointment robot (R) and to transmit and/or receive the one or more of the following commands, the commands comprising: prioritization of information contained in the parameter set (P), to determine obligatory specifications pertaining to information and criteria contained in the parameter set (P) to determine groups with free appointments.

7. A method for an appointment robot (R), the method comprising:
accessing calendar entries by a master module (MA) and creating an appointment robot (R), the appointment robot (R) having a parameter set (P) and a command set (B) associated therewith, and transmitting the appointment robot (R) to one or more client modules (CA1, CA2, CA3) over a data network, and receiving and evaluating groups with provisional appointment entries (T1, T2, T3) from the client modules (CA1, CA2, CA3) to evaluate and to ascertain one or more calendar bookings, and
receiving by one or more client modules (CA1, CA2, CA3) an appointment robot (R) having a parameter set (P) and a command set (B) associated therewith from a master module (MA) and accessing calendar entries and creating a group with provisional appointments (T1, T2, T3) and transmitting the group with provisional appointments (T1, T2, T3) to the master module (MA).

8. The method according to claim 7 and further comprising determining and transmitting a calendar booking from the master module to one or more client modules (CA1, CA2, CA3) and receiving an acknowledgment is by the one or more client modules (CA1, CA2, CA3) and saving the calendar.

9. The method according to claim 7 and further comprising receiving by a master module (MA) a calendar booking from one or more client modules (CA1, CA2, CA3) and saving the calendar booking and transmitting an acknowledgment to the master module (MA).

10. The method according to claim 9 and further comprising accessing by the master module (M) calendar entries saved in multiple calendar databanks and/or the one or more client modules (CA1, CA2, CA3) wherein the calendar databanks comprise at least one calendar databank of a user assigned to the master module (MA) and/or to the one or more client modules (CA1, CA2, CA3) and a calendar databank for saving provisional appointments.

11. The method according to claim 7 and further comprising creating by a master module (MA) and/or by the one or more client modules (CA1, CA2, CA3) in a data format, the data format comprising one or more entries in an iCalendar data format, an appointment robot having an associated parameter set (P), and creating by the client modules (CA1, CA2, CA3) groups with provisional calendar appointments and/or calendar bookings.

12. The method according to claim 7 and further comprising securing by the master module (MA) and/or by the one or more client modules (CA1, CA2 CA3) data including an appointment robot (R) with the associated parameter set (P) and the command set (B), provisional appointment entries, and transmitting in a capsule with security elements, the security elements comprising a hash (11), an electronic signature and/or an electronic encryption and/or the secured capsule, and checking the security elements on receipt.

13. The method according to claim 7 and further comprising creating by the master module (MA) and/or by the one or more client modules (CA1, CA2, CA3) a command set (B) associated with the appointment robot (R) and transmitting and/or receiving the command set, the command set comprising one or more of the following commands: prioritization of information contained in the parameter set (P), obligatory specifications pertaining to information contained in the parameter set (P), and criteria comprising inquiry intervals to ascertain groups with free appointments.

14. A master (M) for an appointment robot (R), the master (M) comprising a master module (MA), wherein the master module (MA) is provided to access calendar entries and to create an appointment robot having a parameter set (P) associated therewith as well as a command set (B) which are secured in a capsule (K) and to transmit them to one or more client modules (CA1, CA2, CA3) over a data network and to receive groups with provisional appointment entries (T1, T2, T3) from the client modules (CA1, CA2, CA3) and to evaluate them in order to ascertain one or more calendar bookings.

15. The master (M) according to claim 14 and further comprising a graphical user interface (G1) for displaying calendar entries by a user of the master (M) in a first calendar (1) and provisional appointment entries (T1, T2, T3) in a second calendar (2) at the same time wherein these calendars (1, 2) are aligned with one another in a time axis.

16. A client (C) for an appointment robot (R), the client (C) comprising a client module (CA), the client module (CA) is provided to receive an appointment robot (R) having a parameter set (P) and a command set (B) associated with it, the appointment robot (R), the parameter set (P) and the command set (B) these being secured in a capsule (K), from a master module (MA) and to access calendar entries and to generate a group with provisional appointment (T1, T2, T3) and to transmit it to the master module (MA).

17. The client (C) according to claim 16 wherein a graphical user interface (G2) is set up to represent simultaneously calendar entries by a user of the client (C) and provisional appointment entries (T1, T2, T3), by representing the calendar entries on calendars (1, 2) aligned side by-side with one another with respect to a time axis.

18. The client (C) according to claim 16, wherein at least one client module (CA1) is represented on a server (S) as a representation (CA1′) wherein this representation (CA1′) contains some or all of the free appointment regions saved in client module (CA1).
